(19) United States
(12) Patent Application Publication
(10) Pub. No.: US 2014/0077901 A1
(43) Pub. Date: Mar. 20, 2014

(54) COMPACT WAVEGUIDE TERMINATION

(71) Applicant: Electronics and Telecommunications Research Institute, (US)

(72) Inventors: Man Seok Uhm, Daejeon (KR); Chang Soo Kwak, Daejeon (KR); So Hyeun Yun, Daejeon (KR); Jang Sup M. Choi, Daejeon (KR); Hong Yeol Lee, Chungcheongbuk-do (KR); Dong Hwan Shin, Daejeon (KR); Youn Sub Noh, Daejeon (KR); In Bok Yom, Daejeon (KR)

(73) Assignee: Electronics and Telecommunications Research Institute, Daejeon (KR)

(21) Appl. No.: 13/856,467

(22) Filed: Apr. 4, 2013

(30) Foreign Application Priority Data
Sep. 18, 2012 (KR) 10-2012-0103563

(51) Int. Cl. H01P 1/26

(52) U.S. Cl. CPC H01P 1/264
USPC 333/22 R

(57) ABSTRACT

Provided is a compact waveguide termination including: a waveguide, a termination coupled with the waveguide and formed with a groove, and a thin film resistor part coupled with the groove and configured to attenuate an input signal at a central region of the waveguide, thereby improving frequency performance.

### CROSS-REFERENCE TO RELATED APPLICATIONS

This application claims priority to and the benefit of Korean Patent Application No. 10-2012-0103563 filed in the Korean Intellectual Property Office on Sep. 18, 2012, the entire contents of which are incorporated herein by reference.

### TECHNICAL FIELD

The present invention relates to a compact waveguide termination, and more particularly, a compact waveguide termination with improved frequency performance.

### BACKGROUND ART

Generally, in a wireless communication system using a millimeter wave band or higher band, a component of a waveguide type with a relatively larger volume than a microstrip line or a coaxial line has been continuously used due to excellent electrical performance.

One of the waveguide component, such as a matched power combiner, and the like, as well as a component required for test is a waveguide termination.

When the waveguide termination is simply used for tests, the volume of the waveguide termination is not limited but when the waveguide termination is used for a part of a microwave band component or a part of automatic test equipment, a compact waveguide termination is required. In particular, frequency characteristics may deteriorates due to manufacturing error at higher frequency band such as millimeter band, and thus a waveguide termination having wideband characteristics while being easily manufactured is required.

Recently, a study on a compact waveguide termination having excellent frequency characteristics and a structure for easily attenuating or dissipating an input signal is being conducted.

### SUMMARY OF THE INVENTION

The present invention has been made in an effort to provide a compact waveguide termination with improved frequency characteristics.

An exemplary embodiment of the present invention provides a compact waveguide termination including: a waveguide; a termination coupled with the waveguide and formed with a groove; and a thin film resistor part connected with the groove and configured to attenuate an input signal to a central region of the waveguide.

In a compact waveguide termination according to the exemplary embodiments of the present invention, a substrate formed with the thin film resistor, of which the patterns are configured easily and is disposed at the central portion of the waveguide at which the electric field is high is connected to the termination, thereby effectively attenuating or dissipating the input signal while maintaining the good reflection loss performance regardless of the variation of a surface resistance value.

In the compact waveguide termination according to the exemplary embodiments of the present invention, the thin film resistor part is easily attached to the termination part, and the waveguide is easily coupled with the termination part with thin film resistor, thereby improving the assembling performance.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

FIG. 1 is an exploded perspective view illustrating a compact waveguide termination according to an exemplary embodiment of the present invention.

FIGS. 2 to 4 are perspective views illustrating various exemplary embodiments of a thin film resistor part illustrated in FIG. 1.

FIG. 5 is a graph illustrating electrical characteristics using the compact waveguide termination illustrated in FIG. 1.

FIG. 6 is a graph illustrating a change in electrical characteristics using the compact waveguide termination illustrated in FIG. 1.

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

In describing components of exemplary embodiments, different reference numerals may be denoted for the components of the same name according to the drawings and the same reference numerals may be denoted for components in different drawings. However, even in this case, it does not mean that the corresponding components have different functions according to the exemplary embodiments or that the corresponding components have the same function in different exemplary embodiments and the functions of each component should be determined based on the description of each component in the corresponding exemplary embodiments.

In describing exemplary embodiments of the present invention, well-known functions or constructions will not be described in detail since they may unnecessarily obscure the understanding of the present invention.

In describing components of the exemplary embodiments, terms such as first, second, A, B, (a), (b), etc. may be used. These terms are used only to differentiate the components from other components. Therefore, the nature, sequence, etc., of the corresponding components are not limited by these terms. When any components are “connected”, “coupled”, or “linked” to other components, it is to be noted that the components may be directly connected or linked to other components, but the components may be “connected”, “coupled”, or “linked” to other components via another component therebetween.

Hereinafter, portions required to understand an operation and an effect of the compact waveguide termination according to an exemplary embodiment will be described in detail with reference to the accompanying drawings.

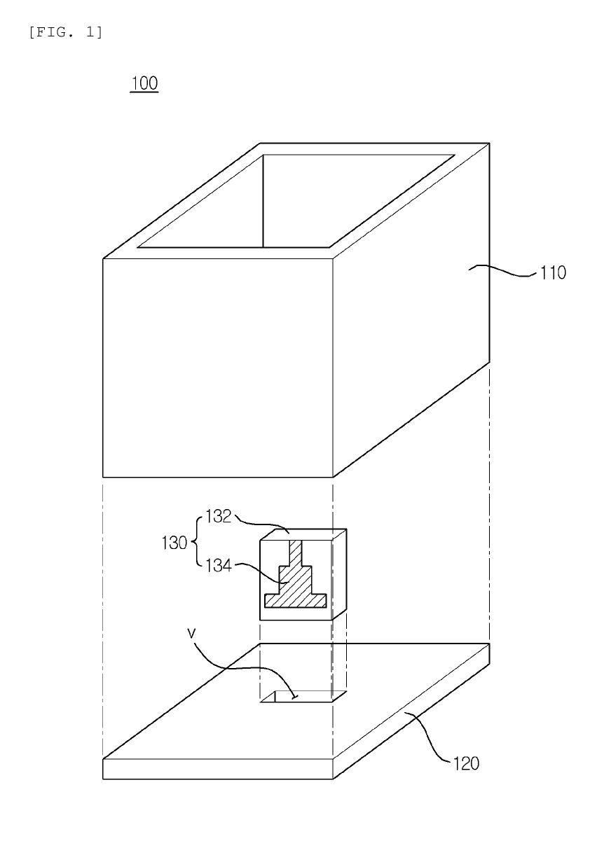

FIG. 1 is an exploded perspective view illustrating a compact waveguide termination according to an exemplary embodiment of the present invention.

Referring to FIG. 1, a compact waveguide termination 100 may include a waveguide 110, a termination part 120, and a thin film resistor part 130.

Here, examples of the waveguide 110 include a metal pipe, is described as a spherical metal pipe having a rectangular shape.

The waveguide 110 may concentrate an input signal on a central portion of the waveguide 100.

The termination part 120 may be coupled with a termination surface of one side of the waveguide 110.

In this case, the termination part 120 may be bonded to the termination surface of one side of the waveguide 110 by an adhesive (not illustrated) to be coupled or may be coupled with the termination surface by a coupling member (not illustrated), but the present invention is not limited thereto.

The termination part 120 may have a groove v formed at a position corresponding to the central portion of the waveguide 110.

The groove v may have the same shape as one side of the thin film resistor part 130 so as to be coupled with the thin film resistor part 130, but the present invention is not limited thereto.

A depth of the groove v is set so that the thin film resistor part 130 is coupled and fixed and may be 0.2 times larger than a thickness of the termination part 120 or may be formed to penetrate through the termination part 120. That is, when the depth of the groove v is 0.2 times smaller than the thickness of the termination part 120, it is difficult to couple and fix the thin film resistor part 130, such that it is highly likely to increase the defects during the manufacturing process.

The thin film resistor part 130 may include a substrate 132, and a thin film resistor 134 formed on the substrate 132.

Here, the substrate 132 has a dielectric constant, for example, may include at least one of aluminum and SiO₂.

The substrate 132 may be formed of a transparent glass material and a dielectric material may be applied on the glass material, but the present invention is not limited thereto.

A shape of the substrate 132 may be foam or a honeycomb, but the present invention is not limited thereto.

The thin film resistor 134 may be formed of at least one of TaN, SiCr, and NiCr and may be formed on the substrate 132 in a step pattern or a taper pattern so as to implement the impedance matching with the input signal.

In this case, the length and width of the thin film resistor 134 may be changed according to the thickness and dielectric constant of the substrate 132, but the present invention is not limited thereto.

That is, the length and width of the thin film resistor 134 and the thickness and dielectric constant of the substrate 132 are closely connected with a resistance value so as to attenuate or dissipate the input signal and thus can be controlled to each other to control the resistance value.

It is possible to couple and fix the groove v and the thin film resistor part 130 by using adhesives, such as epoxy, and the like.

In the compact waveguide termination 100 according to the exemplary embodiment of the present invention, the thin film resistor part 130 including the substrate 132 and the thin film resistor 134 is disposed at the central part of the waveguide 110 and thus may be immediately fastened with the existing waveguide 110 and even when the surface resistance value of the waveguide 110 is changed, the resistance value of the thin film resistor part 130 may be fixed to easily maintain reflection loss performance.

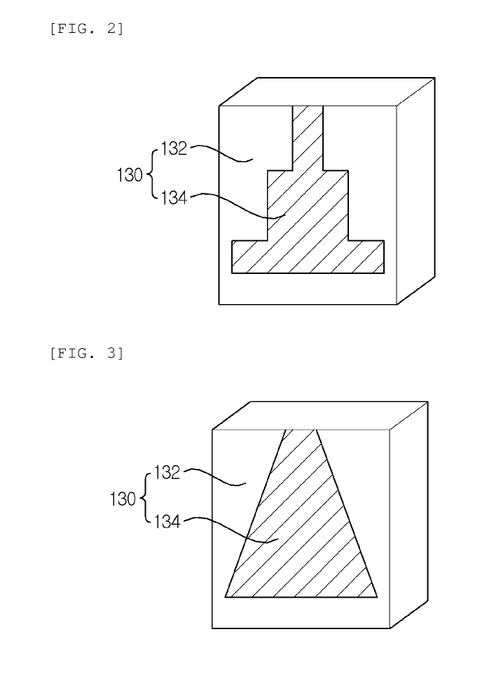

FIGS. 2 to 4 are perspective views illustrating various exemplary embodiments of the thin film resistor part illustrated in FIG. 1.

FIG. 2 is an enlarged view of the thin film resistor part 130 illustrated in FIG. 1.

That is, the thin film resistor part 130 having the thin film resistor 134 formed on the substrate 132 in a step pattern may be formed.

In this case, the thin film resistor 132 may improve the reflection loss characteristics of the input signal input to the waveguide 110.

It can be appreciated that the thin film resistor part 130 illustrated in FIGS. 3 and 4 has the thin film resistor 134 formed in a taper pattern.

In other words, the thin film resistor part 130 illustrated in FIGS. 2 to 4 may have the excellent reflection loss characteristics as the thin film resistor 134 is formed on the substrate 132 in the step pattern or the taper pattern.

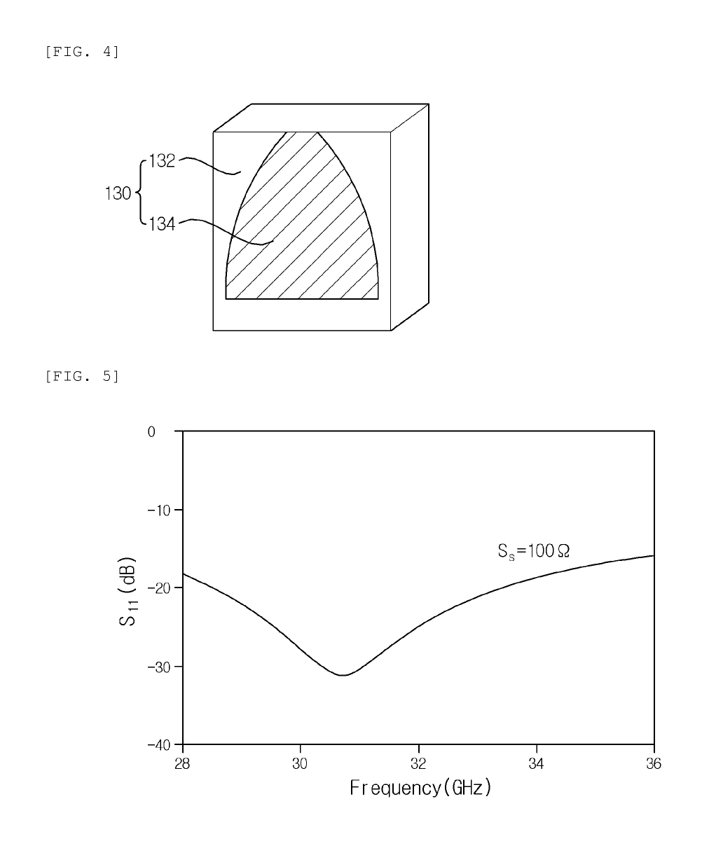

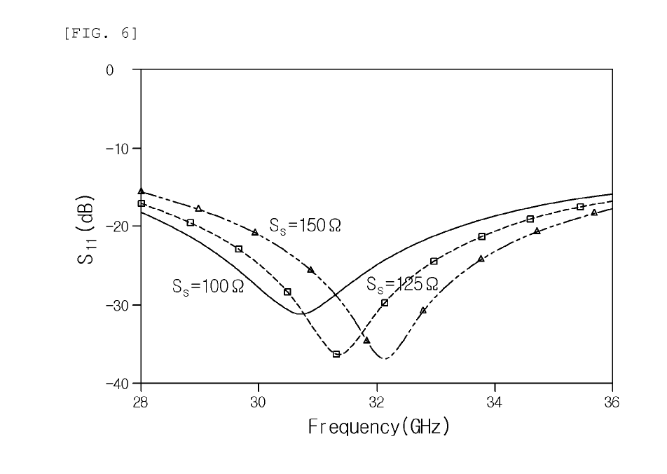

FIG. 5 is a graph illustrating electrical characteristics using the compact waveguide termination illustrated in FIG. 1 and FIG. 6 is a graph illustrating a change in electrical characteristics using the compact waveguide termination illustrated in FIG. 1.

FIG. 5 is a graph of the reflection loss characteristics indicating a performance index obtained by analyzing the performance of the waveguide termination 100 using an electromagnetic analysis tool having high reliability.

Here, the thin film resistor part 130 includes the thin film resistor 134 formed of a TaN which is formed in a three-stage step pattern and of which a resistance value Rs is set to 100Ω and is attached to the substrate 132 having a thickness of 5 mil (0.13 mm) so as to be disposed at the central portion of the waveguide 110.

In this case, the length of the substrate 132 is 7 mm or less and the waveguide 110 is a standard waveguide of WR28 used in a band of 30 GHz.

Here, when the length of the substrate 132 is about 7 mm or less, it can be confirmed that the waveguide termination 100 secures the reflection loss of 15 dB or more in a bandwidth of 25% or more.

FIG. 6 is a graph of a change in electrical characteristics when the resistance value Rs of the thin film resistor 134 of the thin film resistor part 130 included in the waveguide termination 100 is changed.

That is, it can be confirmed that the waveguide termination 100 has similar electrical characteristics within the bandwidth even when the resistance value Rs of the thin film resistor 134 is changed from 100Ω to 150Ω.

As such, the waveguide termination 100 according to the exemplary embodiment of the present invention is used for the band of 30 GHz within the length of the substrate 132 included in the thin film resistor part 130 of about 10 mm and exhibits the reflection loss band of 15 dB or more in the bandwidth of 25% or more, and therefore it can be appreciated that the reflection less performance is improved.

As described above, the exemplary embodiments have been described and illustrated in the drawings and the specification. The exemplary embodiments were chosen and described in order to explain certain principles of the invention and their practical application, to thereby enable others skilled in the art to make and utilize various exemplary embodiments of the present invention, as well as various alternatives and modifications thereof. As is evident from the foregoing description, certain aspects of the present invention are not limited by the particular details of the examples illustrated herein, and it is therefore contemplated that other modifications and applications, or equivalents thereof, will occur to those skilled in the art. Many changes, modifications, variations and other uses and applications of the present construction will, however, become apparent to those skilled in the art after considering the specification and the accompanying drawings. All such changes, modifications, variations and other uses and applications which do not depart from the spirit and scope of the invention are deemed to be covered by the invention which is limited only by the claims which follow.

What is claimed is:

1. A compact waveguide termination, comprising:
a waveguide;
a termination coupled with the waveguide and formed with a groove; and
a thin film resistor part coupled with the groove and configured to attenuate an input signal at a central region of the waveguide.

2. The compact waveguide termination of claim 1, wherein the termination part is disposed on a termination surface of one side of the waveguide, and the groove is formed on a central portion of the waveguide.

3. The compact waveguide termination of claim 1, wherein the thin film resistor part includes:
a substrate; and
a thin film resistor formed on the substrate.

4. The compact waveguide termination of claim 3, wherein the substrate is formed of at least one of alumina and SiO₂.

5. The compact waveguide termination of claim 3, wherein the substrate has a foam or honeycomb shape

6. The compact waveguide termination of claim 3, wherein the thin film resistor is formed of at least of TaN, SiCr, and NiCr.

7. The compact waveguide termination of claim 3, wherein the thin film resistor is formed on the substrate in a step pattern or a taper pattern so as to implement impedance matching with the input signal.

8. The compact waveguide termination of claim 1, further comprising:
an adhesive member configured to couple the groove with the thin film resistor part.
